(19) United States
(12) Patent Application Publication
(10) Pub. No.: US 2025/0046541 A1
(43) Pub. Date: Feb. 6, 2025

(54) PUSH BUTTON

(71) Applicant: EATON INTELLIGENT POWER LIMITED, Dublin 4 (IE)

(72) Inventors: Nico CLAUSNITZER, Geisig (DE); Bruno Veronezi FUENTES, Cologne (DE); Hans Juergen SDUNTZIG, Königswinter (DE); Deepak SANAN, Bonn (DE); Viktor PAHL, Neustadt (DE)

(21) Appl. No.: 18/709,286

(22) PCT Filed: Nov. 18, 2022
(86) PCT No.: PCT/EP2022/025522

§ 371 Date: May 10, 2024

(30) Foreign Application Priority Data
Nov. 24, 2021 (EP) 2116941.2

(51) Int. Cl. H01H 13/14; H01H 13/20

(52) U.S. Cl. CPC H01H 13/14; H01H 13/20

(57) ABSTRACT

Some embodiments relate to a push button provided for usage with a microswitch as contact element is disclosed. The push button comprises a push button guide predetermining a predefined travel distance of the push button, a plunger movable inside the push button guide over the predefined travel distance, and a switch bridge actuatable by the plunger and provided for actuating a switching element arranged underneath the switch bridge, wherein the switch bridge is made flexible at least at a portion provided for actuating the switching element

### CROSS-REFERENCE TO RELATED APPLICATIONS

This application is a national phase filing under 35 C.F.R. § 371 of and claims priority to PCT Patent Application No. PCT/EP2022/025522, filed on Nov. 18, 2022, which claims the priority benefit under 35 U.S.C. § 119 of Great Britain Patent Application No. 2116941.2, filed on Nov. 24, 2021, the contents of which are hereby incorporated in their entireties by reference.

### BACKGROUND

The present disclosure relates to a push button provided for usage with a microswitch as contact element.

The RMQ-Titan® series of the applicant allow combinations of actuating elements with contact elements to provide push buttons. For example, RMQ-Titan® type M22 and M30 push buttons are designed for corresponding type M22 and M30 contact elements, respectively. These contact elements have predetermined switching travels and are designed for forces in a specific range.

As a rule, it is only possible to use the actuating elements with other contact elements if the contact elements have the specified switching travels and are designed for the specified force range of the corresponding actuating element. For example, it is not possible to combine a pushbutton of the RMQ-Titan® series M22 and M30 with a microswitch without further ado, since neither the specified switching travel would be sufficient to actuate the microswitch, nor the specified force range during actuation is suitable for microswitches.

### SUMMARY

This disclosure provides a push button provided for usage with a microswitch as contact element.

An embodiment provides a push button comprising: a push button guide predetermining a predefined travel distance of a button or other component for communicating push force to a plunger; a plunger movable inside the push button guide over the predefined travel distance; and a switch bridge actuatable by the plunger and provided for actuating a switching element arranged underneath the switch bridge, wherein the switch bridge is flexible at least at a portion provided for actuating the switching element. The push button guide allows to reduce the travel distance into a much shorter distance required for a microswitch actuation and may also restrict side-ways movements by longer and narrower guidance surface compared to existing guides of the push buttons of the RMQ-Titan® series. The switch bridge may be specifically designed for actuating of particularly a microswitch as switching element.

In embodiments, the switch bridge may be made from a flexible plastic material so as to form a damper protecting the switching element.

In further embodiments, the push button may comprise a suspension element arrangeable between the plunger and the push button guide to push the plunger away from the switching element. The suspension element may be for example in embodiments a coil spring coaxially arrangeable to the plunger. The suspension element may serve as a damper protection the switching element since it acts against pressing forces exerted on the plunger and so may protect the switching element from high forces.

In further embodiments, the plunger comprises two first legs and two second legs, wherein the length of the two first legs is larger than the length of the two second legs, and wherein the two first legs hold the plunger at a non-pressed position of the push-button and the two second legs are provided to actuate the switch bridge.

In further embodiments, the switch bridge comprises at least one arch arrangeable between the two first legs and provided to guide the switch bridge between the two first legs. The arch may be also made flexible so as to provide damping for the damper's low end exerting forces on the switching element.

In further embodiments, two extensions may extend from the at least one arch and projecting beyond the two second legs. The two second legs of the plunger may engage with the two extensions of the switch bridge and transfer the movement of the plunger to the switch bridge to exert a force on the switching element via the switch bridge.

In further embodiments, the push button may comprise a front ring attachable to the push button guide for fixing the push button on a panel together with a thread ring screwable on the front ring so that at least a part of the push button guide is clamped between the front ring and the thread ring.

Further features will be apparent from the following description in conjunction with the embodiments shown in the drawings. Other features and advantages will be apparent from the description and drawings, and from the claims.

### DESCRIPTION OF DRAWINGS

FIG. 1 shows an exploded perspective view of a push button provided for usage with a microswitch as contact element according to an embodiment;

FIG. 2 shows a perspective view of the switch bride of the push button of FIG. 1;

FIG. 3 shows a perspective view of the push button guide of the push button of FIG. 1;

FIG. 4 shows a perspective view of a PCB holder provided for usage with the push button of FIG. 1;

FIG. 5 shows a perspective view of an assembly of the push button guide, the plunger, the front ring and the thread ring of the push button of FIG. 1; and

FIG. 6 shows a cross sectional via of the assembled push button.

### DETAILED DESCRIPTION

In the following description, identical, functionally identical and functionally related elements may be given the same reference signs. Absolute values are only given as examples in the following and are not to be understood as restrictive.

One objective of the push button disclosed herein is to allow to safely use a standard microswitch as the main contact or switching element for a mechanical push button instead of mechanical contact blocks. While actuating a microswitch from a mechanical plunger the push button travel distance may be reduced into a much shorter distance required for the microswitch actuation with the herein disclosed push button. Furthermore, the mechanic tolerance between all the parts of a push button, which may become very important, can be overcome with the herein disclosed push button. Yet further, the concept of the herein disclosed push button may allow to use a standard microswitch as the main contact element.

For implementation of an embodiment of the herein disclosed push button the following parts were added to an existing push button, for example to the M30 push button from the Applicant:
switch bridge: this new part, which may be at least partly made of for example a flexible plastic material, is used to actuate the microswitch and may serve as a damper protecting the microswitch.
PCB (Printed Circuit Board) holder: this optional new part has the function to constrain the height of the microswitch to the top surface.

Important factors such as wall thickness and plunger travel distance matters.

For implementation of an embodiment of the herein disclosed push button the following parts from an existing push button such as the M30 push button from the Applicant were modified:
push button guide: this part was modified to reduce the plunger travel distance (Z-axes) for example from 5.5 mm to 2 mm and to restrict side-ways movements by a longer and narrower guidance surface.
plunger: this part was modified by making its height smaller to allow the PCB to be positioned closer to the push button reducing the overall height of the combination of the elements of the push button.

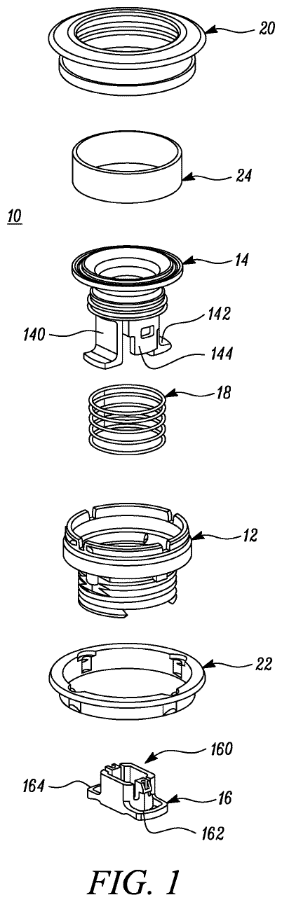

FIG. 1 shows an embodiment of a push button 10 in a perspective and exploded view.

The central element is the push button guide 12, which serves as a guide for a plunger 14 and predetermines a predefined travel distance of the push button, for example from 5.5 mm to 2 mm. The guide 12 may be also designed to restrict side-ways or lateral movements of the plunger 14 within the guide 12.

The plunger 14 is movable inside the push button guide 12 over the predefined travel distance. The plunger 14 may comprise two first legs 140, 142 oppositely arranged in circumferential direction of the plunger 14. The plunger may further comprise two second legs 144, 146 (only one of them is visible in FIG. 1). The length of the first legs 140, 142 may be larger than the length of the second legs 144, 146, which are also oppositely arranged in circumferential direction of the plunger 14 so that the first and second legs are alternately arranged in circumferential direction of the plunger 14. The two first legs 140, 142 may hold the plunger at a non-pressed position of the push-button. The two second legs 144, 146 may be provided to actuate a switch bridge 16 as described below in detail. The two first legs 140, 142 may be shaped as feet at their bottom portion.

The switch bridge 16 is made flexible at least at a portion provided for actuating the switching element. It may particularly comprise a flexible portion, for example made from a flexible material such as a flexible plastic material or a spring material. The switch bridge 16 may comprise an arch 160 and two extensions 162, 164 extending on opposite sides from the arch 160. The arch 160 may serve as an actuator of the switching element, particularly microswitch positioned below the arch 160 of the switch bridge. The arch 160 may form the flexible portion of the switch bridge 16. For example, the arch 160 may be made from a flexible material such as a flexible plastic material or a spring material. The arch 160 may be arranged between the two first legs 140, 142. The two extensions 162, 164 may project beyond the two second legs 144, 146 such that the two second legs 144, 146 can actuate the switch bridge 16, particularly move the switch bridge 16 downwards. Also, the entire switch bridge 16 may be made flexible, particularly from a flexible material such as a flexible plastic material or spring material.

A suspension element 18 such as a coil spring may be arranged between the plunger 14 and the push button guide 12 to push the plunger 14 away from the switching element. The holder may be for example a PCB, to which the switching element may be attached, or the above-described PCB holder, an embodiment of which is shown in FIG. 4, and which may be attached to a PCB. The suspension element 18 may reduce the forces exerted by the plunger 14 on the switching element and, thus, serve as a damper protecting the switching element, particularly reduce the forces acting on the switch element or microswitch.

The entire push button 10 may be attached to a panel (not shown) with a front ring 20, which is attachable to the push button guide 12 for fixing the push button 10 on the panel together with a thread ring 22 screwable on the front ring so that at least a part of the push button guide 12 may be clamped between the front ring 20 and the thread ring 22. A guide ring 24 may be further provided and arranged coaxially between the front ring 20 and the push button guide 12.

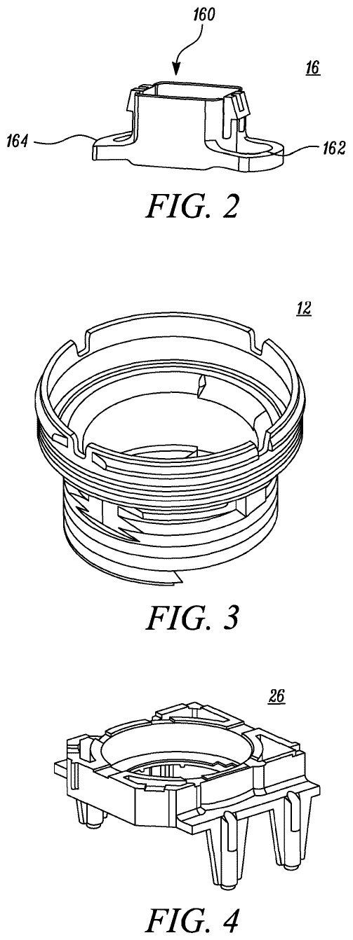

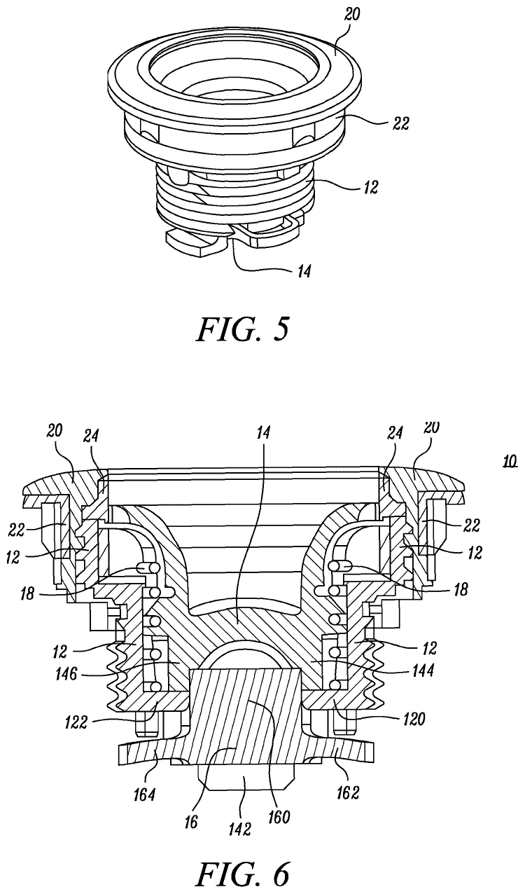

FIGS. 2 and 3 show the switch bridge 16 and the push button guide 12, respectively, in perspective views. FIG. 4 shows a PCB holder 26 in a perspective view. FIG. 5 shows a perspective view of the assembled push button guide 12, the plunger 14, the front ring 20 and the thread ring 22.

The push button 10 is operated as follows: forces exerted on the plunger 14 for example by means of a button (not shown) attached to the top of the plunger 14 compress the suspension element 18. The first and second legs 140, 142, 144, 146 move downward and the second legs 144 transfer the forces exerted on the plunger 14 to the extensions 162, 164, which thus press the arch 160 downward on the switching element to actuate it. The forces exerted by the arch 160 on the switching element may be reduced by a flexible portion of the switch bridge 16, for example a flexible arch 160. When the forces exerted on the plunger 14 are reduced or removed, the suspension element 18 can press the plunger upwards, i.e., away from the switching element so that the actuation of the switching element can be terminated.

FIG. 6 shows a cross sectional view of the assembled push button 10. As can be seen, the plunger 14 is arranged inside the push button guide 12 over a travel distance predefined particularly by limiting protrusions 120, 122 at the bottom of the guide 12, which also prevent the plunger 14 from falling out of the guide 12 at the bottom. The coil spring 18 arranged between the guide 12 and the plunger 14 Further, the two second “short” legs 144, 146 can be seen in FIG. 6. The arch 160 of the switch bridge 16 projects into the plunger 14 and the push button guide 12 as shown in the position illustrated in FIG. 6.

1. A push button comprising:
a push button guide predetermining a predefined travel distance of a push button or other component for communicating push force to a plunger;
a plunger movable inside the push button guide over the predefined travel distance; and
a switch bridge actuatable by the plunger and provided for actuating a switching element arranged underneath the switch bridge, wherein the switch bridge is flexible at least at a portion provided for actuating the switching element.

2. The push button of claim 1, wherein the switch bridge is made from a flexible plastic material so as to form a damper protecting the switching element.

3. The push button of claim 1 comprising a suspension element (18) arrangeable between the plunger and the push button guide to push the plunger away from the switching element.

4-7. (canceled)

8. The push button of claim 2 comprising a suspension element arrangeable between the plunger and the push button guide to push the plunger away from the switching element.

9. The push button of claim 3, wherein the plunger comprises two first legs and two second legs, wherein the length of the two first legs is larger than the length of the two second legs, and wherein the two first legs hold the plunger at a non-pressed position of the push-button and the two second legs are provided to actuate the switch bridge.

10. The push button of claim 8, wherein the plunger comprises two first legs and two second legs, wherein the length of the two first legs is larger than the length of the two second legs, and wherein the two first legs hold the plunger at a non-pressed position of the push-button and the two second legs are provided to actuate the switch bridge.

11. The push button of claim 9, wherein the switch bridge comprises at least one arch arrangeable between the two first legs and provided to guide the switch bridge between the two first legs.

12. The push button of claim 10, wherein the switch bridge comprises at least one arch arrangeable between the two first legs and provided to guide the switch bridge between the two first legs.

13. The push button of claim 11, wherein two extensions extend from the at least one arch and projecting beyond the two second legs.

14. The push button of claim 12, wherein two extensions extend from the at least one arch and projecting beyond the two second legs.

15. The push button of claim 13 comprising a front ring attachable to the push button guide for fixing the push button on a panel together with a thread ring screwable on the front ring so that at least a part of the push button guide is clamped between the front ring and the thread ring.

16. The push button of claim 14 comprising a front ring attachable to the push button guide for fixing the push button on a panel together with a thread ring screwable on the front ring so that at least a part of the push button guide is clamped between the front ring and the thread ring.
